(19) United States
(12) Patent Application Publication
(10) Pub. No.: US 2013/0168993 A1
(43) Pub. Date: Jul. 4, 2013

(54) PROTECTIVE MAT FOR AUTOMOTIVE TRUNK AND BUMPER

(71) Applicant: Alan Gramet, Pawleys Island, SC (US)

(72) Inventor: Alan Gramet, Pawleys Island, SC (US)

(21) Appl. No.: 13/730,107

(22) Filed: Dec. 28, 2012

Related U.S. Application Data
(60) Provisional application No. 61/583,047, filed on Jan. 4, 2012.

(51) Int. Cl. B60R 13/01

(52) U.S. Cl. CPC B60R 13/011
USPC 296/39.1

(57) ABSTRACT

A protective mat for a cargo area and bumper of an automotive vehicle, comprising a flexible sheet having an upper surface, a lower surface, a leading edge, and a trailing edge; a reinforced portion of the lower surface; a first indicia disposed on the upper surface in a first region opposed to and indicative of the longitudinal location of the reinforced portion; a fastener portion disposed on the lower surface at the leading edge for removably attaching the mat to an interior surface of the automotive cargo area; and a weighting apparatus disposed at the trailing edge, wherein the lower surface is disposed against the vehicle when the mat is placed into use when the cargo area is in an open position. The mat preferably is formed of a material selected from the group consisting of plastic sheeting and fabric such as terry cloth.

### RELATIONSHIP TO OTHER APPLICATIONS AND PATENTS

Reference is made to and this application claims priority from and the benefit of U.S. Provisional Application Ser. No. 61/583,047, filed Jan. 4, 2012, entitled “PROTECTIVE MAT FOR AUTOMOTIVE TRUNK OPENING AND BUMPER,” which application is incorporated herein in its entirety by reference.

### TECHNICAL FIELD

The present invention relates to protective mats for external surfaces of automobiles and other vehicles, and further relates to flexible protective mats for protecting surfaces of trunks, bumpers, and fenders, and further relates to protecting clothing from becoming soiled through contact with dirty pumpers and fenders. Such protective mats desirably may be furled within and unfurled from a vehicle trunk or cargo space.

### BACKGROUND OF THE INVENTION

Automotive vehicles, when driven, typically collect dirt, dust, and grease on the outer rear panel of the trunk or cargo area, bumper, and other parts of the automobile body adjacent to the opening of the trunk or cargo area. When an individual loads objects into, or unloads objects from, the trunk or cargo area, the individual's clothing and body are often brushed by, or leaned against, the outer rear panel, bumper, or fender, resulting in the clothing getting dirty and/or the contacted [symbol] (e.g., golfing, tennis, hiking, skiing, etc.), the individual may use the outer rear panel, bumper or fender of the vehicle for support and may lean his or her back or buttocks against one or more of these areas when changing into sports shoes or donning other sporting equipment, which can also result in clothing getting dirty and/or damage to the vehicle's surface.

Still further, even when currently available protective mats are installed in, or adjacent to, the trunk lid or cargo door of a vehicle, the lid or door can accidentally close on the mat and damage it.

There is therefore a need in the art for a protective mat for the external surfaces of automobiles and other vehicles that can protect an individual's body or clothing from dirt, dust, and grease, can protect the surface of the vehicle from scratching or other damage during loading, unloading, or when an individual leans against the rear panel of the vehicle, and can resist damage to the mat caused by [symbol] section of this application shall not be considered an admission that such reference is available as prior art to the present invention.

### SUMMARY OF THE INVENTION

A protective mat 100 for an automotive vehicle is provided. The mat preferably comprises fabric or other easily cleanable, rollable, and/or foldable material, but can be any suitable material known in the art. In specific embodiments, the fabric can be a woven cloth material, such as, but not limited to, a low-pile fleece material, terry cloth, toweling, or other type of fabric that preferably is fluid-absorbing. In a specific embodiment, the mat can be used as an absorbent towel when not in use and/or installed on the vehicle. Preferably, the mat 100 is removable, washable, and [symbol] one embodiment, a protective mat 100 for an automotive trunk opening or bumper is provided comprising: an upper surface 110; a lower surface 120; a leading edge 200; a trailing edge 300; a reinforced portion 400; a sleeve or pocket 500; a weighting element 600 insertable into the sleeve or pocket; and a fastener portion 700.

In one embodiment, the mat can additionally comprise a custom logo 800.

In another embodiment, the mat can additionally comprise another logo 900 indicating the location of the reinforced portion 400.

The mat 100 can comprise a top or leading edge 200 that has a fastening apparatus such as a strip of fasteners 700, such as VELCRO® or snaps, that can attach to the inside wall of the trunk (or trunk panel or cargo area) of an automotive vehicle (e.g., automobile, car, sports utility vehicle, truck, etc.). The body of the mat 100 can unroll or unfold (unfurl) to cover the rear panel, bumper, and/or fender of the vehicle.

The mat can comprise a dowel, rod, or other weighting element 600 incorporated (e.g., sewn) into the bottom or trailing edge 300 of the mat, which incorporation may be removable.

In another embodiment, the mat can comprise a reinforced portion 400, e.g., a rubberized or plastic reinforcing/protective strip of rubberized or plastic protrusions, applied to the upper 110 or preferably lower 120 (i.e., under) side of the mat approximately 8-12 inches from the leading edge 200 that is placed to protect that mat from damage (e.g., perforation or tearing) from accidental engagement with the trunk latch and/or the edge of the trunk opening.

### BRIEF DESCRIPTION OF THE DRAWINGS

The present invention is described herein with reference to the accompanying drawings, in which similar reference characters denote similar elements throughout the several views. It is to be understood that, in some instances, various aspects of the invention may be shown exaggerated or enlarged to facilitate an [symbol] of the upper surface of an embodiment of the protective mat 100 constructed in accordance with the present invention;

FIG. 2 is a plan view of the lower surface of an embodiment of the protective mat 100 constructed in accordance with the present invention;

FIG. 3 is a first photograph of a portion of the lower surface shown in FIG. 2;

FIG. 4 is a second photograph of the lower surface shown in FIG. 3; and

FIG. 5 is a third photograph of the lower surface shown in FIG. 3.

### DETAILED DESCRIPTION OF THE INVENTION

A protective mat 100 is provided for an automotive trunk opening or bumper attachable to the inside of a vehicle trunk or cargo area. The mat can be unrolled, extended to cover the rear panel, bumper, and/or fender of the vehicle and can be these areas from scratches, abrasions or other damage. The mat can also be used to undesirable contact between a person and an exterior surface of the vehicle when trunk or cargo area. In a specific embodiment, exterior surfaces of the vehicle adjacent trunk lip are protected from contact with an individual, and an individual's body and protected from contact with surfaces of the vehicle, when an individual rests or leans body against those surfaces.

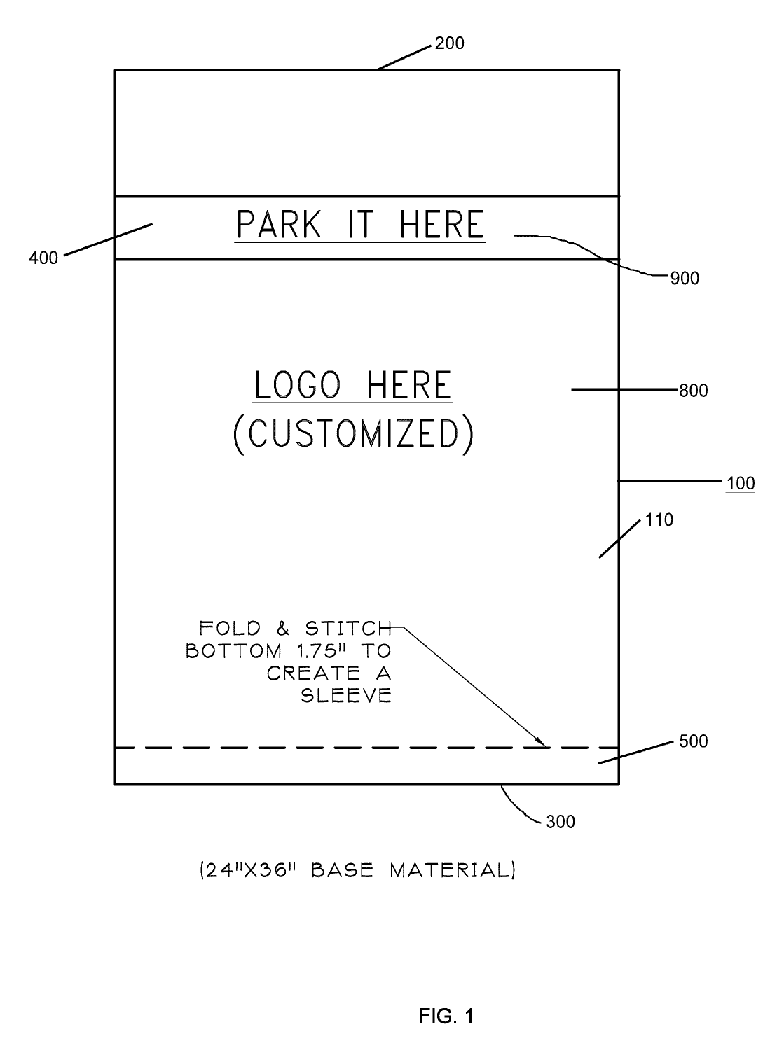

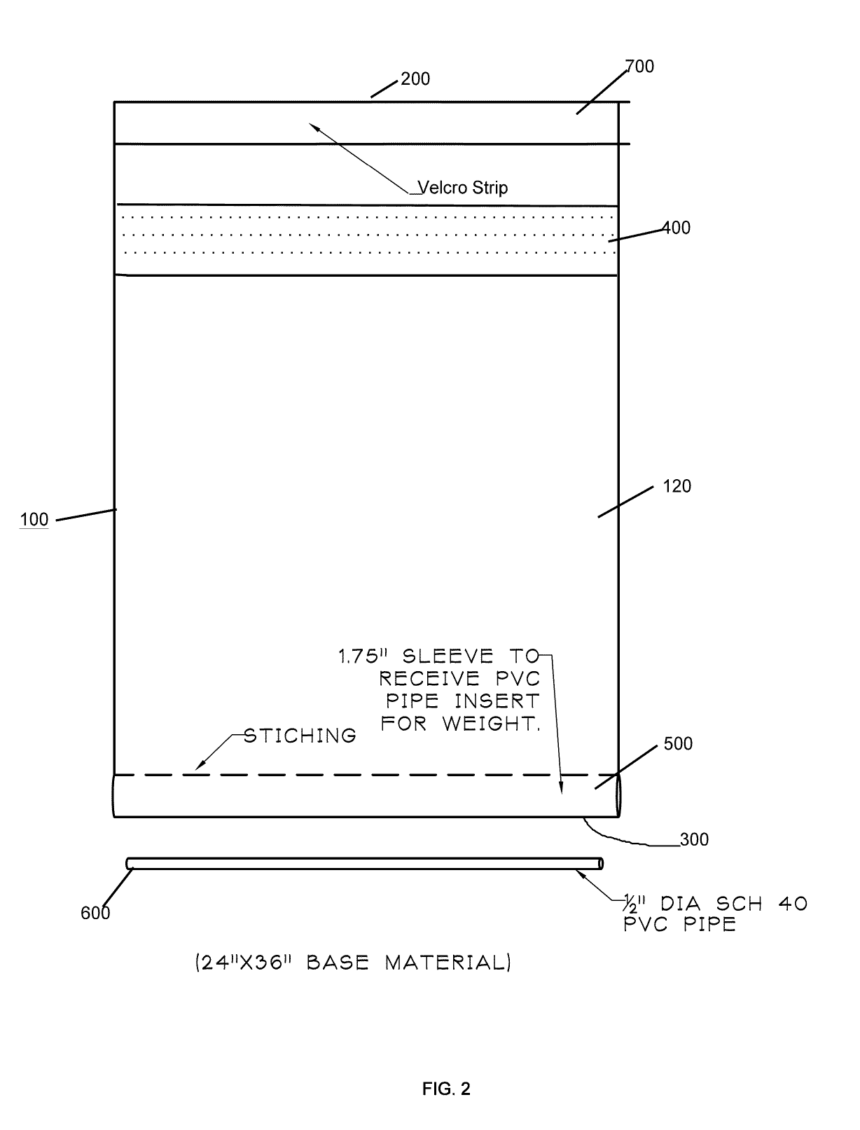

The mat preferably comprises fabric or other easily cleanable, rollable and/or foldable material, but can be any suitable material known in the art. In specific embodiments, the fabric can be a woven cloth material, such as, but not limited to, a low-pile fleece material, terry cloth, toweling, or other type of fluid-absorbing fabric. In a specific embodiment, the mat can be used as an absorbent towel when not in use [symbol] is attachable to the inside of a vehicle trunk (e.g., an automobile trunk) or cargo area, and can fold or roll into or out of the vehicle trunk or cargo area. In use, the protective mat can be unrolled, unfolded, or extended to cover the rear panel, bumper, and/or fender of the vehicle. The mat can, in various embodiments, drape over the trunk lip, an exterior surface of the vehicle adjacent to the trunk, and/or an adjacent fender and/or bumper, and can be used to protect these [symbol] desirable contact between a person and an exterior surface of the vehicle when accessing the trunk or cargo area. For example, the mat can be used to protect a person's clothing from dirt and grime on the vehicle surface. In a specific embodiment, exterior surfaces of the vehicle adjacent to the trunk lip are protected from contact with an individual, and an individual's body and clothing is protected from contact with surfaces of the vehicle, when an individual rests or leans his or her body, e.g., back or buttocks, against those surfaces. Any automotive vehicle (e.g., automobile, car, sports utility vehicle, truck, etc.) with a trunk or cargo area can be afforded protection through use of the protective mat of the [symbol] protective mat is preferably generally rectangular in shape. Suitable dimensions of the mat can be easily determined by the skilled artisan. The dimensions of the mat can be customized to cover and/or protect the vehicle trunk lip, cargo area, rear panel, etc. of the vehicle to be covered. In one embodiment designed to fit many makes and models of vehicles (FIGS. 1-2), the mat is approximately 36 inches long (from leading to trailing edge) and 24 inches wide from side to side.

The protective mat is preferably made of a relatively flexible and lightweight material such as a fabric or plastic, and in various embodiments can match or coordinate with the interior or exterior of the vehicle or can match or coordinate with another desired color.

FIG. 1 shows a diagram of the upper surface 110 of an embodiment of the protective mat 100 constructed in accordance with the present invention. The mat comprises a leading (top) edge 200 and a trailing (bottom) edge of mat 300.

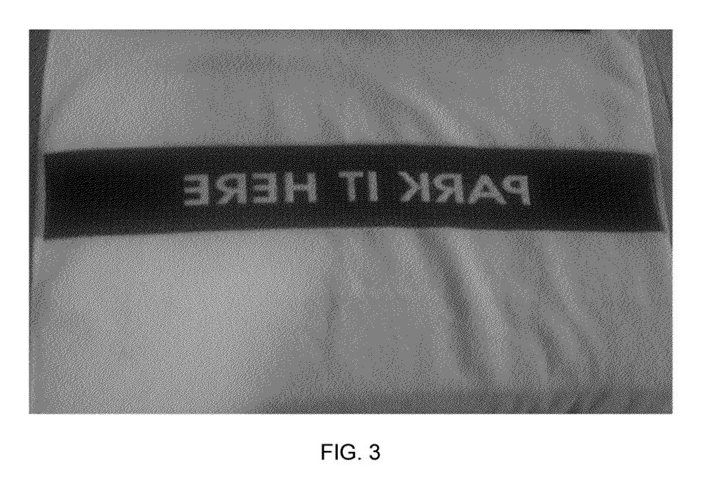

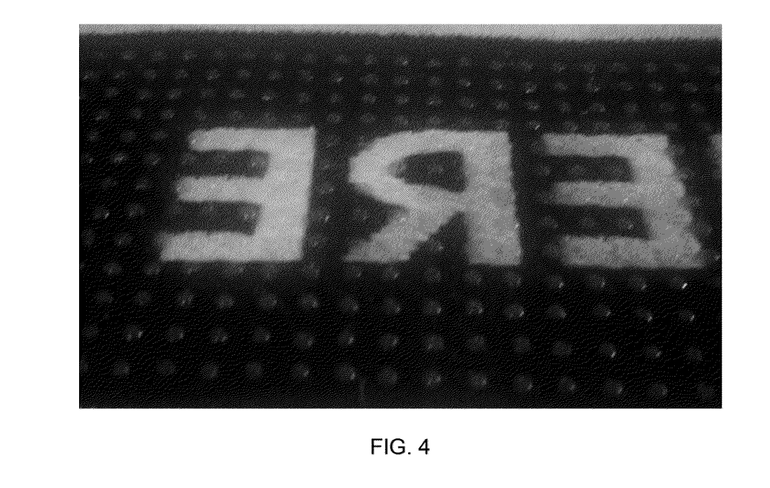

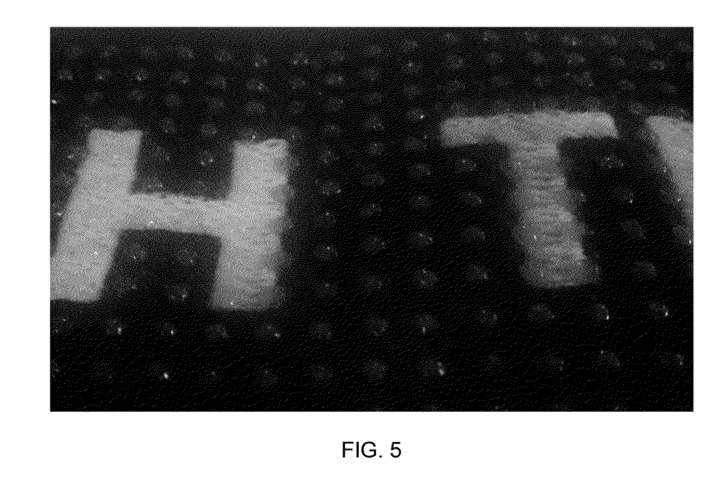

The mat 100 comprises a reinforced portion 400. The reinforced portion can comprise, for example, a rubberized or plastic reinforcing/protective strip applied to the upper surface 110 (as shown in FIG. 1) or lower surface 120 (underside, as shown in FIG. 2) of the mat preferably approximately 8-12 inches from the leading edge. In one embodiment shown in FIGS. 3-5, the reinforced portion can comprise an array of rubberized protrusions, each protrusion being approximately one eighth of an inch in diameter and spread apart approximately one quarter inch on center. Each protrusion is approximately one sixteenth of an inch in height. In another embodiment, the reinforced portion can comprise rubberized or plastic protrusions for reinforcement. In another embodiment, the reinforced portion can be a pressed rubber decal. Other suitable reinforcing materials known in the art can also be used. The reinforced portion is positioned on the mat to protect the mat from damage (e.g., perforation or tearing) through contact with the trunk latch and/or the edge of the trunk. The rubberized or plastic reinforcement can be applied using methods well known in the art. For example, rubberized protrusions (e.g., comprising silicone, rubber, mixture of silicone and [symbol] the [symbol] being a desired colored, displaying a desired or custom logo 800, and/or provided with reflective or other markings. In a specific embodiment, the upper surface can further comprise an optional logo 900 (see FIG. 1, “PARK IT HERE”) indicating the location of the reinforced portion 400. Logos and other decorative elements displayed on the surface of the mat can be formed onto, or affixed to, the mat using any suitable method known in the art, e.g., printing, embroidered stitching, [symbol] diagram of the lower surface (underside, 120) of an the protective mat. The mat can comprise a fastener portion 700 for attaching the mat interior of the trunk or cargo area. The fastener portion 700 can be positioned near the leading edge 200 of the mat. The fastener portion can comprise any fastening example, a plurality or strip of fasteners, such as hook and loop/pile fasteners (e.g., snaps, loops or buckles, that may attach to corresponding fasteners positioned in the e.g., to the interior wall or trunk panel, of the vehicle trunk or cargo area. In the shown in FIG. 2, the VELCRO® fastener strip is positioned on the back/rear side of the adjacent to the top or leading edge.

The mat can also comprise a bottom (trailing, distal to trunk lip) edge 300. The bottom edge of the mat can comprise one or more pockets, slots, or sleeves 500 into which one or more weighting elements 600 (e.g., a drapery weight, a rod or a dowel) can be inserted, preferably removably. The one or more pockets, slots, or sleeves can be formed by any suitable method known in the art, e.g., stitching, gluing, adhering, fusing, and the like. In a preferred embodiment, the sleeve can be formed, for example, by folding over the bottom edge 300 of the mat and stitching it place. In FIG. 2, the exemplary weighting element 600 is a 22-inch length of ½ inch diameter [symbol] or other graphic decoration 900 (see FIG. 1 “PARK IT HERE” logo) can be positioned on the mat so that the logo can be matched or aligned with the trunk lock and/or trunk lip.

FIG. 3 is a photograph of the rear view of an embodiment of the protective mat showing the lower surface or underside. The fabric of this embodiment of protective mat is terry cloth. The reinforced portion comprises the dark rubberized protuberances (“buttons”) and the “PARK IT HERE” logo indicates the location of the [symbol] a close-up photograph of the rear view of the protective mat shown in FIG. 3, showing the reinforced portion comprising the dark rubberized [symbol] 5 is another close-up photograph of the rear view of the protective mat shown in FIG. 3, showing the reinforced portion comprising the dark rubberized [symbol] mat can also be accompanied by a set of directions or instructions. The user can be instructed, for example, to unroll or unfold (“unfurl”) the mat over the trunk lip, to align (“line up”) a word or graphic decoration above the trunk lock, and to fasten the mat to the rear interior trunk panel.

Using the specific embodiment depicted in FIG. 1 as an example, the directions can read:
1. Unroll mat
2. Line up the “IT” in “PARK IT HERE” with the trunk lock.
3. Remove backing from VELCRO® fastener tape.
4. Repeat step 2, adhering sticky backing of fastener to rear trunk panel.
   In a certain embodiment, the user can be instructed that if the interior of the trunk or rear trunk panel is “fabric,” the backing from the (two-part) VELCRO® fastener should be removed and the hook (stiff) portion of the VELCRO® strip attached directly to the loop (soft) portion of the VELCRO® strip.

The present invention is not to be limited in scope by the specific embodiments described herein. Indeed, various modifications of the invention in addition to those described herein will become apparent to those skilled in the art from the foregoing description. Such modifications are intended to fall within the scope of [symbol] cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A protective mat for a cargo area and bumper of an automotive vehicle, comprising:
a) a flexible sheet having an upper surface, a lower surface, a leading edge, and a trailing edge;
b) a reinforced portion of said lower surface;
c) first indicia disposed on said upper surface in a first region opposed to and indicative of the longitudinal location of said reinforced portion;
d) a fastener portion disposed on said lower surface at said leading edge for removably attaching said protective mat to an interior surface of said automotive cargo area; [symbol] weighting apparatus disposed at said trailing edge,
wherein said lower surface is disposed against said vehicle when said protective mat is placed into use when said cargo area is in an open position.

2. A protective mat in accordance with claim 1 wherein said flexible sheet is formed of a material selected from the group consisting of plastic sheeting and fabric.

3. A protective mat in accordance with claim 2 wherein said fabric is terry cloth.

4. A protective mat in accordance with claim 1 wherein said automotive cargo area is a car trunk.

5. A protective mat in accordance with claim 1 wherein said reinforced portion comprises an array of rubberized protrusions extending outward from said lower surface.

6. A protective mat in accordance with claim 1 wherein said reinforced portion is longitudinally disposed such that in use of said protective mat said reinforced portion covers a latching mechanism of said trunk.

7. A protective mat in accordance with claim 1 wherein said mat is in a form selected from the group consisting of reliable and foldable.

8. A protective mat in accordance with claim 1 wherein said fabric is absorbent of water and oils.

9. A protective mat in accordance with claim 1 wherein said protective mat is removable, washable, and re-usable.

10. A protective mat in accordance with claim 1 wherein said reinforcing portion is formed to prevent sliding of said mat against a finished surface of said vehicle.

11. A protective mat in accordance with claim 1 wherein said fastener portion comprises apparatus selected from the group consisting of hook and loop/pile fasteners, snaps, loops, and buckles.

12. A protective mat in accordance with claim 1 further comprising second indicia disposed on said upper surface in a second region separate from said first region of said first indicia.
